(19) United States
(12) Patent Application Publication
(10) Pub. No.: US 2006/0146645 A1
(43) Pub. Date: Jul. 6, 2006

(54) MagnaStir

(76) Inventor: William Joseph Rosener, Tahlequah, OK (US)

Correspondence Address: William Rosener;Jodie Rosener, 820 Sasha Lane, Tahlequah, OK, 74464, US

(21) Appl. No.: 10/906,048

(22) Filed: Feb. 1, 2005

Related U.S. Application Data
(63) Continuation-in-part of application No. 10/905,470, filed on Jan. 6, 2005, now abandoned.

(51) Int. Cl. B01F 13/08

(52) U.S. Cl. 366/274

(57) ABSTRACT

MagnaStir automatically stirs foods on the cooktop. An electromagnet(s) moves immediately below a non-magnetic (e.g., stainless steel, glass, or aluminum) pot or pan which is secured to the cooktop. Inside the pot or pan is placed a metal (i.e., magnetic) device called the MagnaStir paddle. When MagnaStir is turned on, the electromagnet(s) becomes magnetic and starts moving. This causes the MagnaStir paddle which has been placed within the pot or pan to move, thus stirring the food. Using this invention, 1) the setup time for using a motorized stirring mechanism will be substantially reduced, 2) the motorized unit will be hidden from the user resulting in a clear, unobstructed view of the food being stirred, 3) a lid could be place over the pot or pan while the food is stirring and cooking, and 4) the user could more easily mix, stir, and cook using only one pot or pan.

MagnaStir automatically stirs foods on the cooktop. An electromagnet(s) moves immediately below a non-magnetic (e.g., stainless steel or glass) pot or pan which is secured to the cooktop. Inside the pot or pan is placed a metal (i.e., magnetic) device called the MagnaStir paddle. When MagnaStir is turned on, the electromagnet(s) becomes magnetic and starts moving. This causes the MagnaStir paddle which has been placed within the pot or pan to move, thus stirring the food.

The electromagnet(s) could move in various patterns. A few such patterns and descriptions will be listed, although these patterns should not be construed as limiting the scope of the invention but as merely providing illustrations of some of the presently preferred embodiments of this invention. One approach would be to use two electromagnets as shown in FIGS. 1A. In this case the electromagnets would orbit around the center of the heating element magnetically pulling a MagnaStir paddle whose width was slightly less than the width of the pot or pan. A second approach would be to use a single electromagnet as shown in FIG. 1B. In this case the electromagnet would orbit around the center of the heating element magnetically pulling a MagnaStir paddle whose width was approximately half the width of the pot or pan. A third approach would be to use a single electromagnet as shown in FIG. 1C. In this case the electromagnet would spin around the center of the heating element magnetically pulling a MagnaStir paddle whose width was slightly less than the width of the pot or pan. A fourth approach would to use a single electromagnet as shown in FIG 1D. In this case the electromagnet would spin on its axis as it orbits around the center of the heating element magnetically pulling a MagnaStir paddle whose width was approximately half the width of the pot or pan. The fourth pattern listed above would be very similar to how some counter-top mixers work or how the earth spins around the sun. This additional spin could be accomplished in numerous ways. One approach would be to use an additional variable speed motor. Another approach is to place a swivel and a small gear between the electromagnet and the rotating device that spins the electromagnetic. The electromagnet would be fastened to the small gear. As the electromagnet rotates, (i.e., in the larger orbit) the small gear would walk inside the larger gear causing the electromagnet to spin on its axis as shown in FIG. 6. These gears would most likely be made of non-magnetic material (stainless steel). If this later approach is used, the number of teeth should be selected so that the rotation of the MagnaStir paddle changes slightly with each rotation. Regardless of the approach used, electrical swivel(s) would most likely be used to avoid tangles in the power supply cord to the electromagnets. Locking electrical swivel connections are currently available on the market. Regardless of the approach used, the closer the electromagnets are to the center of the heating element, the less likely miscellaneous metal (magnetic) objects on the cooktop would rotate. Other possibilities and combinations of moving the electromagnet could include half turns, and a back and forth action. Various methods could be used to move the electromagnet below the pot or pan including an electric motor as shown in the drawings or even magnetic fields.

The rotation speed of the electromagnet(s) could be regulated to increase or decrease the speed of stirring. It (they) could even be set on an intermittent rotation. For example, it (they) could rotate once every 4 minutes. The strength of the rotating electromagnet(s) might also be adjustable. For example, the strength may need to be increased when stirring thick food.

Non-customized pots or pans could be fastened to the cooktop using numerous approaches. For example, brackets could hold the sides of pots and pans; they could be secured by their handles; or a binding action that takes advantage of the downward force of the electromagnetic(s). Customized pots or pans could also be secured using a variety of methods including 1) a twist and lock action, 2) indentations in the pan which match raised pegs on the cooktop or vice versa, or 3) magnetically. The indentation approach would assure the pan was correctly positioned. However, if magnetically fastened with stationary magnets, (see FIG. 5), the cooktop could remain undisturbed. Regardless, sensors could be installed so that MagnaStir only works with non-magnetic pots or pans. These sensors could also allow MagnaStir to only work if the pot or pan was correctly placed on the cooktop.

This approach is totally different from other motorized stirrers on the market which typically 1) adhere to the top of a saucepan, or 2) have paddles which are directly connected to the motorized unit. Consequently, the stirring mechanism interferes with observing the food and adding additional ingredients. Using my invention, 1) the setup time for using a motorized stirring mechanism will be substantially reduced, 2) the motorized unit will be hidden from the user resulting in a clear, unobstructed view of the food being stirred, 3) a lid could be place over the pot or pan while the food is stirring and cooking, and 4) the user could more easily mix, stir, and cook using only one pot or pan. Numerous searches have been performed showing no previous art in this area.

The drawings in this invention assume a flat, ceramic glass cooktop where the electromagnet is located immediately below the glass. However, this idea covers all cooktops. For example, with many gas and electric coil ranges, the burners are slightly raised above the cooktop. Regardless of the heating method used, the rotating electromagnet would be raised to a height immediately below the pot or pan. In the case of gas or electric coil burners, either they would need to be created from a non-magnetic material or they would have to be located a distance from the pull of the electromagnet. The source of the heat does not matter and could include: gas, propane, electric, wood, coal, etc.

This paragraph provides a static description of the figures and the reference numerals used in the drawings. In the drawings, closely related figures have the same number but different alphabetic suffixes.

### DRAWING FIGURES

FIGS. 1A to 1D show a top view of the cooktop.

FIGS. 2A to 2C show a side view of the cooktop.

FIGS. 3A and 3B show a side view of the MagnaStir paddle

FIGS. 4A and 4B show a top view of the MagnaStir paddle

FIG. 5 shows a side view of a specially designed pan.

FIG. 6 shows how gears could be used to make the electromagnet spin on its axis as it orbits around the center of the heating element.

Reference Numerals in Drawings

| | |
|---|---|
| 20 | moving or spinning or rotating electromagnet |
| 22 | stationary electromagnet |
| 24 | MagnaStir paddle |
| 26 | non-magnetic pot or pan (e.g., stainless-steel or glass) |
| 28 | non-magnetic cooktop (e.g., stainless-steel or glass) |
| 30 | metal (magnetic) |
| 32 | buttons to vary the speed and strength of the rotating |
| | electromagnet |
| 34 | paddle |
| 36 | hole |
| 38 | thin non-metallic surface protects the bottom of a pot or |
| | pan |
| 40 | metal feet/base |
| 42 | handle |
| 44 | power supply to electromagnet |
| 46 | motor |
| 48 | electrical swivel |
| 50 | pulley |
| 52 | support braces for pulley |
| 54 | mechanical swivel |
| 56 | large gear |
| 58 | small gear |

### DESCRIPTION OF FIGURES

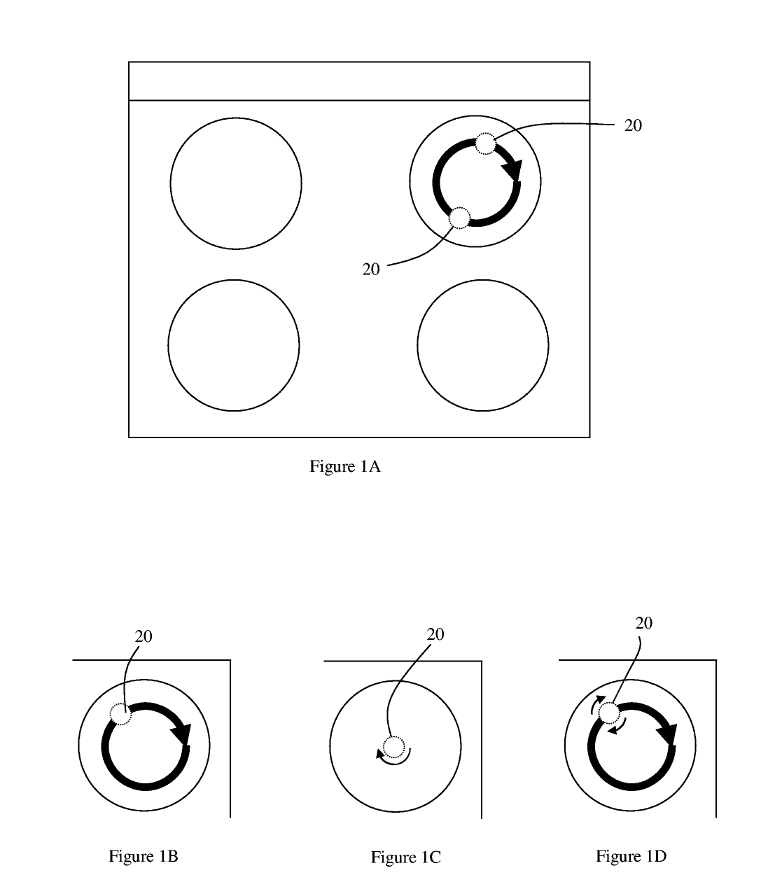

FIG. 1A to 1D show top views of the cooktop. FIG. 1A shows two electromagnets orbiting around the center of the heating element. FIG. 1B shows a single electromagnet orbiting around the center of the heating element. FIG. 1C shows a single electromagnet spinning on its axis. FIG. 1D shows a single electromagnet spinning on its axis as it orbits around the center of the heating element.

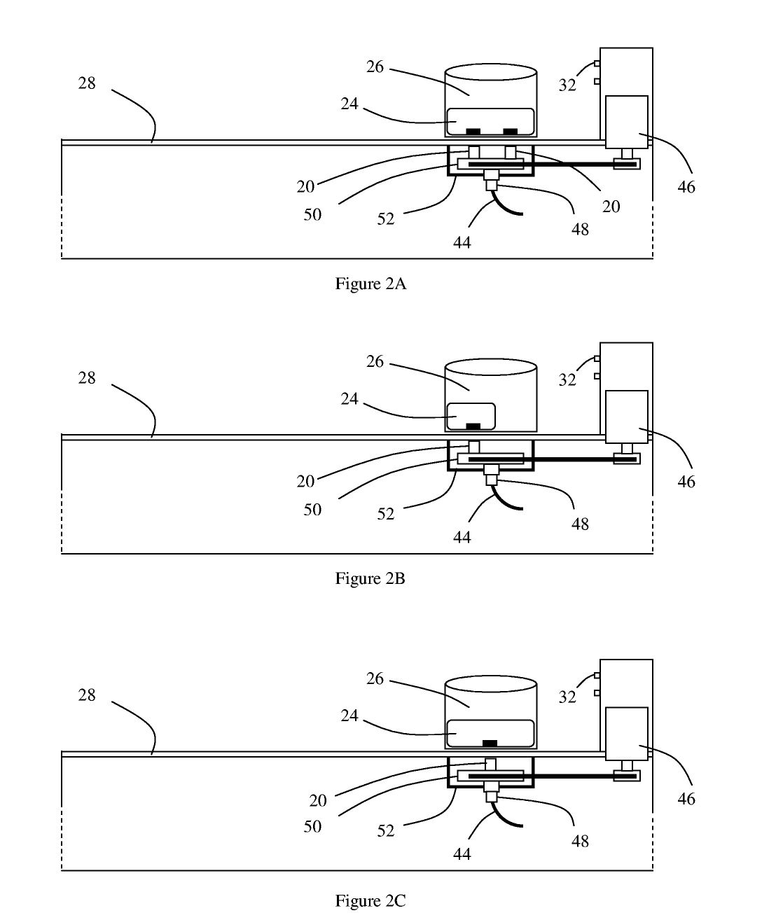

FIGS. 2A to 2C show side views of the cooktop. FIG. 2A shows how two electromagnets could pull one large MagnaStir paddle as would be the case in the first approach discussed in Para 2. FIG. 2B shows how one electromagnet could pull a smaller MagnaStir paddle as would be the case in the second and fourth approaches discussed in Para 2. FIG. 2C shows how one electromagnet could rotate one large MagnaStir paddle as would be the case in the third approach discussed in Para 2.

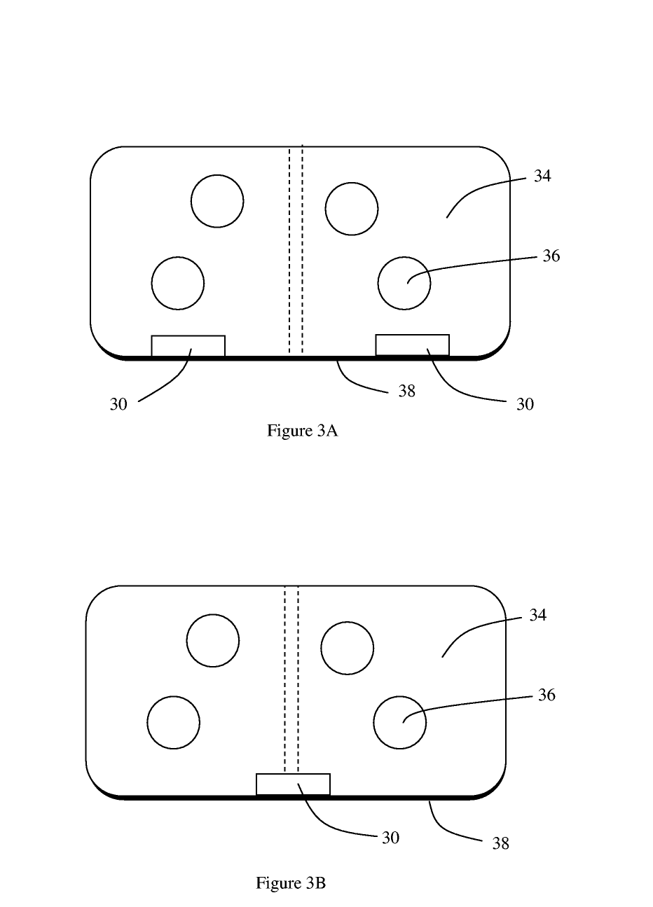

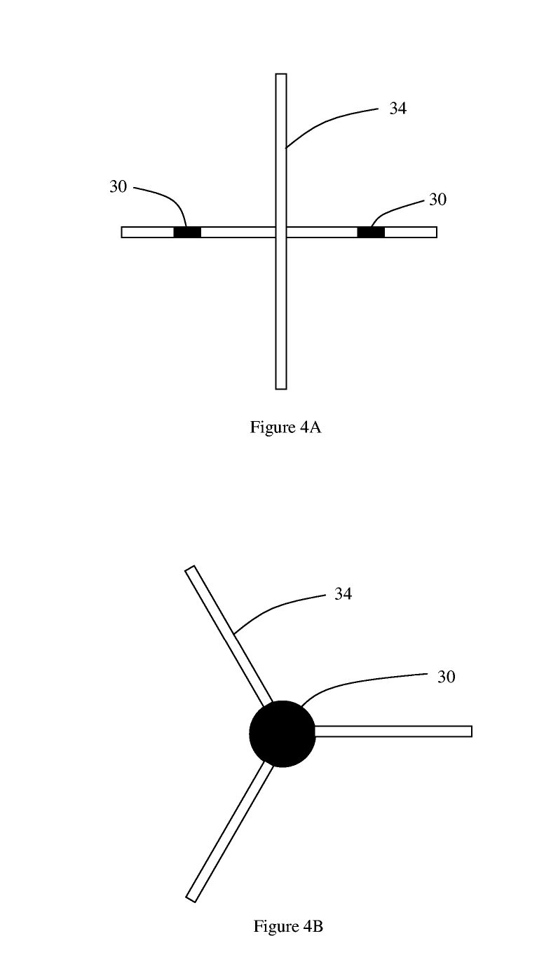

FIGS. 3A and 3B show side view variations of the MagnaStir paddle. FIGS. 4A and 4B show top view variations of the MagnaStir paddle. Depending on the height of the food in the pot or pan, MagnaStir paddles could have 1) paddles that are adjustable in height, 2) could allow additional paddles to be added on, or 3) various height MagnaStir paddles could be included. The shape of the MagnaStir paddle would ideally be designed to match the curvature of the pot or pan. The design of the MagnaStir paddle could vary considerable. For example it might be designed with more or less paddles. It could be designed with no paddles, like a rotating cup. As another example, a bottom could be placed on the MagnaStir paddle. Of course the size (width, height, and thickness) of the MagnaStir paddle could vary depending upon the movement of the electromagnet and the size of the pots and pans.

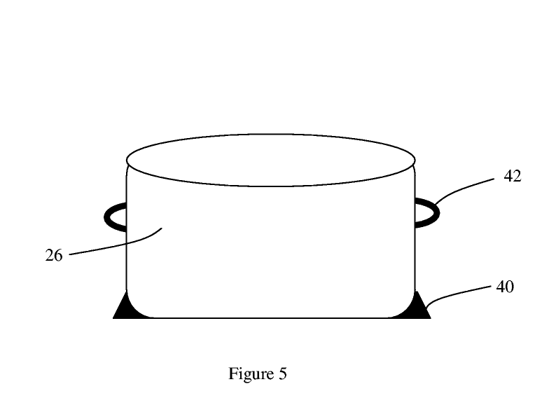

FIG. 5 shows a side view of how a pot or pan could be modified to allow stationary electromagnet(s) to hold it in place. In one case, the pot or pan could be held magnetically, at the base. In the other case, the pot or pan could be held either magnetically or non-magnetically by the handle. This last approach would allow non-customized pots or pans to work.

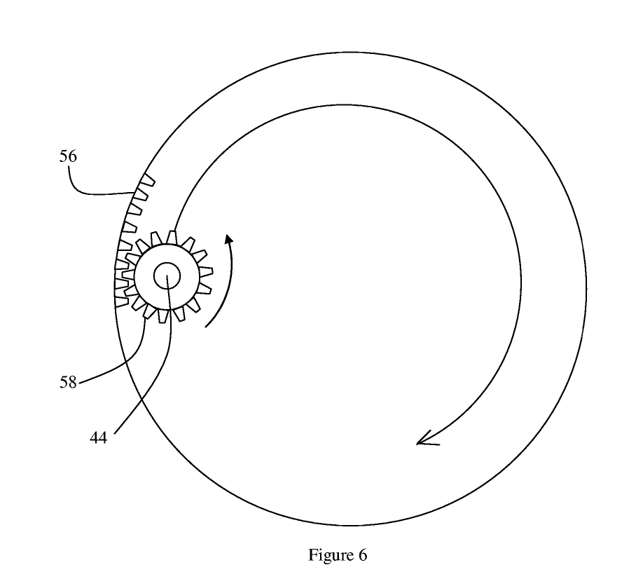

FIG. 6 shows how gears could be used to have the electromagnet spin on its axis as it orbits around the center of the heating element.

The descriptions listed above should not be construed as limiting the scope of the invention but as merely providing illustrations of some of the presently preferred embodiments of this invention. For example, the number of electromagnet(s) could vary, the movement of the electromagnet(s) could vary, stationary magnet(s) could be used, the power supply could vary, the source of heat could vary, the size and shape of the MagnaStir paddle could vary, etc. This idea would apply to any process that would benefit from stirring such as 1) stirring food in a microwave oven, 2) stirring food in a stand-alone unit not part of an oven, range, or microwave, 3) stirring either warm or cold foods, such as an ice cream maker, 4) stirring of non-food items, 5) as a cleaning device for dirty pots and pans, and 6) other uses. The scope of the invention should be determined by the claims and their legal equivalents, rather than by the examples given.

What is claimed is:

1. What I claim as my invention is the ability to stir or mix food and other materials through the use of a moving electromagnet or electromagnets.

2. Said electromagnetic or electromagnets of claim 1 could move in a variety of motions and directions.

3. Said electromagnet or electromagnets of claim 1 could rotate on an intermittent basis.

4. Speed and strength of said electromagnet or electromagnets of claim 1 could be regulated.

5. A stationary electromagnet or electromagnets could be used to hold items being stirred.
